(19) United States
(12) Patent Application Publication
(10) Pub. No.: US 2025/0172490 A1
(43) Pub. Date: May 29, 2025

(54) IDENTIFYING A MATERIAL OF AN ADDITIVELY MANUFACTURED COMPONENT

(71) Applicant: KRONES AG, Neutraubling (DE)

(72) Inventors: Johannes KARL, Reichenstetten (DE); Stephanie ALLGEIER, Regensburg (DE); David POEPPEL, Pentling (DE)

(21) Appl. No.: 18/956,937

(22) Filed: Nov. 22, 2024

(30) Foreign Application Priority Data
Nov. 23, 2023 (DE) 10 2023 132 636.8

(51) Int. Cl. G01N 21/31; B29C 64/118; B29C 64/386; B33Y 10/00; B33Y 50/00; G01N 21/64

(52) U.S. Cl. CPC G01N 21/31; B29C 64/386; B33Y 50/00; G01N 21/64; B29C 64/118; B33Y 10/00

(57) ABSTRACT

The invention relates, inter alia, to a method for identifying a material of a component. The method comprises providing the component, which is manufactured via an additive manufacturing device. The method comprises irradiating the component with electromagnetic radiation via a radiation source. The method comprises recording a spectrum of the irradiated component via a recording device. The method comprises evaluating the recorded spectrum for a match with at least one predetermined spectrum which is associated with a predetermined material having at least one nanoparticle marker for identifying the predetermined material, via an evaluation device. The method comprises outputting a result of the evaluation via an output device.

### CROSS REFERENCE TO RELATED APPLICATIONS

This application claims the benefit under 35 U.S.C. § 119(a) of German Patent Application No. DE 10 2023 132 636.8, filed Nov. 23, 2023, entitled IDENTIFYING A MATERIAL OF AN ADDITIVELY MANUFACTURED COMPONENT, and whose entire disclosure is incorporated by reference herein.

### TECHNICAL FIELD

The invention relates to a method and a mobile terminal for identifying a material of an additively manufactured component. The invention further relates to an additively manufactured component and a method for its production.

### TECHNICAL BACKGROUND

The use of additive manufacturing for the on-site supply of customers with replacement parts or wearing parts has the potential of considerably reducing installation downtimes and storage costs. For example, the customer can additively manufacture a corresponding replacement part or wearing part for the installation directly on site when the part is required.

However, the on-site supply of customers with spare or wearing parts using additive manufacturing also entails certain risks. For example, when inserting a material filament spool into the additive manufacturing device, a customer may mix up the material filament spools and use an incorrect material filament spool with, for example, an incorrect material. This can cause the additive manufacturing device itself to not work, as the different filaments may require different temperatures, etc. in order to be printable at all.

On the other hand, it may happen that the customer installs an apparently suitable component or spare part into the machine after additive manufacturing, but the component does not withstand the corresponding influences in the machine because it is made of the wrong material.

To prevent an additive manufacturing device from producing a component from an incorrect material, DE 10 2022 107 007 A1, for example, discloses a method for operating an additive manufacturing device.

DE 10 2010 007 566 A1 describes an anti-counterfeiting system with a security element for the unique marking of all types of products. The security element comprises a covert or overt security feature to distinguish pirated copies or imitations of a product from the original. The security feature consists of at least one inorganic luminescent pigment.

With regard to the further prior art, reference is made to DE 10 2016 125 471 A1, DE 10 2017 118 601 A1 and WO 2021/176097 A1.

The invention is based on the object of creating an improved technology for testing and ensuring a desired component quality of an additively manufactured component, preferably for a container treatment plant.

### SUMMARY OF THE INVENTION

The object is achieved by the features of the independent claims. Advantageous developments are specified in the dependent claims and the description.

One aspect of the present disclosure relates to a method for identifying a material of a component, preferably a container treatment plant. The method comprises providing the component, which is manufactured (e.g. entirely) via an additive manufacturing device. The method further comprises irradiating the component with electromagnetic radiation via a radiation source. The method further comprises recording a spectrum, preferably an emission and/or absorption spectrum, of the irradiated component via a recording device (e.g. comprising a camera, a spectrometer and/or a hyperspectral camera). The method further comprises evaluating the recorded spectrum for a (e.g. complete, partial or predominant) match with at least one predetermined spectrum (spectrum property) which is associated with a predetermined material having at least one nanoparticle marker (marker made of nanoparticles) for (e.g. uniquely) identifying the predetermined material, via an evaluation device. The method further comprises outputting a result of the evaluation via an output device (e.g. a visual, acoustic and/or haptic output device).

Advantageously, the method can make it possible to detect whether the additively manufactured component was actually additively manufactured from the desired material. For this purpose, nanoparticles are used as markers with which the material can be clearly and reliably identified by spectrum analysis. This can advantageously ensure that the correct material was used for the additively manufactured component, which can have a positive effect on component, product and/or production reliability (e.g. storage, correct component in the machine, etc.). Advantageously, the nanoparticles used as markers do not change the properties of the (base material of the) predetermined material. The method also allows for batch tracking and unique identifiability of materials marked with at least one nanoparticle marker for individual identification.

Preferably, UV radiation, VIS radiation or infrared radiation can be used as the electromagnetic radiation.

Preferably, any radiation source for emitting electromagnetic radiation in the ultraviolet, visible or infrared range can be used as the radiation source. The radiation source can be, for example, an LED, a laser, a gas discharge lamp, a halogen lamp or an incandescent lamp.

Preferably, when evaluating for a match with the spectrum of the at least one predetermined material, it is possible in particular to check whether or not the at least one nanoparticle marker can be identified in the recorded spectrum, preferably an emission and/or absorption spectrum. This can be recognized in the recorded spectrum via selective absorption and/or emission peaks, bands, signal attenuation or signal deletion, intensity maxima or intensity minima, or other characteristic signal shapes of the at least one nanoparticle marker.

Preferably, the nanoparticle marker (marker made of nanoparticles) can have a nanoparticle size between 1 nm and 100 nm.

Preferably, the nanoparticle marker can be selected from any optically and spectroscopically identifiable substances. These substances can be chemically and physically stable within a base material of the predetermined material and have little or no adverse effect on the material properties. Well suited substances that can be used as nanoparticle markers are organic dyes and/or complex compounds, organic luminescent agents and/or inorganic luminescent agents. These luminescent agents are already widely used in the identification of objects, for example in the case of banknotes and other valuable documents. Organic dyes and/or complex compounds and/or luminescent agents can be selected from organically conjugated systems, such as fluorescein derivatives, coumarin derivatives, oxazine derivatives, rhodamine derivatives, lumogens, pyrromethene dye derivatives or others. For the use of complex compounds, rare earth complexes with Eu3+, Tb3+, Sm2+, Sm3+, Nd3+, Ce3+, Pr3+, Pr4+, Dy3+, Ho3+, Er3+, Tm3+Yb2+ or Yb3+ are used, but also complex compounds with Ru3+, Cr3+, Mn2+, Mn3+, Mn4+, Fe3+, Fe4+, Fe5+, Co3+, Co4+Ni2+, or Cu+ complexed with organically conjugated ligands, such as acetylacetone (ACAC), dibenzoylmethane (DBM), 4,4,4-trifluoro-1-(2-naphthyl)-1,3-butanedione (TFNB), thenoyltrifluoroacetone (TTFA), bipyridine derivatives, phenanthroline derivatives or other organic complexing ligands.

Inorganic luminescent agents can be selected solid-state compounds containing one or more luminescent ions from the group In+, Sn2+, Pb2+, Sb3+, Bi3+, Ce3+, Ce4+, Pr3+, Nd3+, Sm2+, Sm3+, Eu2+, Eu3+, Gd3+, Tb3+, Dy3+, Ho3+, Er3+, Tm2+, Tm3+, Yb2+, Yb3+, Ti3+, V2+, V3+, V4+, Cr3+, Mn2+, Mn3+, Mn4+, Fe3+, Fe4+, Fe5+, Co3+, Co4+, Ni2+, Cu+, Ru2+, Ru3+, Pd2+, Ag+, Ir3+, Pt2+ and Au+. Preferred inorganic luminescent pigments are binary, ternary or quaternary halides, oxides, oxyhalides, sulfides, oxysulfides, sulfates, oxysulfates, selenides, nitrides, oxynitrides, nitrates, oxynitrates, phosphides, phosphates, carbonates, silicates, oxysilicates, vanadates, molybdates, tungstates, germanates or oxygermanates of the elements Li, Na, K, Rb, Mg, Ca, Sr, Sc, Y, La, Ti, Zr, Hf, Nb, Ta, Zn, Gd, Lu, Al, Ga and In.

Particularly preferably, the predetermined material is a plastic material, preferably PA CF, PA, TPU, PLA or Tough PLA, having the at least one nanoparticle marker.

In one exemplary embodiment, the radiation source, the recording device and the output device, and optionally the evaluation device, are integrated in a mobile (portable) terminal, preferably a handheld terminal. The method can thus be advantageously carried out particularly ergonomically and, for example, directly at the machine in which the component is or is to be installed, or at any other desired location.

In a further exemplary embodiment, the method further comprises retrieving, when a match with the predetermined spectrum associated with the predetermined material is found during the evaluation, additional information associated with this predetermined material from a data store (e.g. the evaluation device, the mobile terminal or a server device), The method may further comprise outputting the retrieved additional information via the output device. Preferably, the additional information may comprise at least one of a material number, a material designation, a batch number, a material production time, a digital reference (link) to an electronic file (e.g. document), a data sheet, an instruction manual and a material composition. Advantageously, this means that further information about the component and/or the material can be output to the user in addition to the mere identification of the material, whereby the use of the component and, optionally, the knowledge of the user can be further improved.

In one embodiment, the method further comprises at least one of the following:
enabling operation of a machine (e.g. in which the component is installed or is to be installed) if, during evaluation, a match is found with a predetermined spectrum associated with a predetermined material that is desired for this machine and that has at least one nanoparticle marker, and/or
sending the result of the evaluation to a server device, preferably a cloud server device; and/or
adapting an operation of a machine (e.g. in which the component is installed or is to be installed) depending on the result of the evaluation.

Advantageously, this allows further actions to be carried out beyond simply identifying the material, for example to prevent damage to the machine or to the objects being treated by the machine as a result of the wrong component material.

In a further embodiment, the component is formed entirely from a plurality of adjacent additively manufactured (e.g., plastic) material layers (e.g., PA CF, PA, TPU, PLA, or Tough PLA material layers), and all material layers comprise one or more different nanoparticle markers. Alternatively or additionally, providing the component comprises:
mixing a base material granulate, preferably a plastic granulate (e.g. PA CF, PA, TPU, PLA or Tough PLA granulate), with one nanoparticle marker or a plurality of different nanoparticle markers to form a mixture;
extruding the mixture to form a filament; and
producing the component from the filament via the additive manufacturing device.

The advantage of this is that the component can be examined from any side, and even when it is worn or destroyed, such that the method can also be used, for example, to analyze the cause of machine, product (e.g. container) or component defects that have already occurred.

A further aspect of the present disclosure relates to a system configured to carry out a method for identification as disclosed herein.

A further aspect of the present disclosure relates to a mobile terminal, preferably a handheld terminal, for identifying a material of an additively manufactured component. The mobile terminal comprises a radiation source for irradiating a component with electromagnetic radiation. The mobile terminal comprises a recording device (e.g. comprising a camera, a spectrometer and/or a hyperspectral camera) for recording a spectrum, preferably an emission and/or absorption spectrum, of the irradiated component. The mobile terminal comprises an (e.g., visual, acoustic and/or haptic) output device for outputting information to a user. The mobile terminal comprises an evaluation device that is configured to evaluate a spectrum, recorded by the recording device, of the component irradiated by the radiation source for a (e.g. complete, partial or predominant) match with at least one predetermined spectrum associated with a predetermined material having at least one nanoparticle marker (marker made of nanoparticles) for (e.g. uniquely) identifying the predetermined material, and/or for the purpose of evaluation for a match with at least one predetermined spectrum (spectrum property) associated with a predetermined material having at least one nanoparticle marker for (e.g. uniquely) identifying the predetermined material, to send said recorded spectrum to a server device via a (e.g. wireless) communication interface (e.g. radio, WLAN, Bluetooth, NFC and/or infrared communication interface) and optionally to receive a result of the evaluation from the server device via the communication interface. The evaluation device is further configured to operate the output device to output a/the result of the evaluation. Advantageously, the same advantages can be achieved with the mobile terminal that have already been described herein with reference to the method.

In one exemplary embodiment, the evaluation device is further configured to operate a (e.g. wireless) communication interface (e.g. radio, WLAN, Bluetooth, NFC and/or infrared communication interface) of the evaluation device in order to send the result of the evaluation to a machine and/or to a server device.

In a further exemplary embodiment, the evaluation device is further configured to operate the output device in order to output additional information associated with the predetermined material if, during the evaluation, a match with the predetermined spectrum associated with this predetermined material is found, wherein the additional information preferably comprises at least one of a material number, a material designation, a batch number, a material production time, a digital reference (link) to an electronic file (e.g. document), a data sheet, operating instructions and a material composition.

In one embodiment, at least one of the following is fulfilled:
when the result is output, information about a lack of match is output if no match is found during the evaluation;
when the result is output, information about an existing match is output if a match is found during the evaluation;
when the result is output, information about the predetermined material is output if, during the evaluation, a match with the predetermined spectrum associated with this predetermined material is found.

Advantageously, the user can thus be easily informed whether the component he has tested was actually additively manufactured with the desired material for the intended use.

In a further embodiment, the at least one nanoparticle marker has a total volume and/or weight proportion in the predetermined material of ≥0.5% and/or ≤3% (e.g. ≥0.6% and/or ≤1%). Particularly advantageously, this substantially does not cause any changes in the material properties, but still enables safe and reliable detection of the nanoparticle marker.

In one embodiment variant, the at least one nanoparticle marker is a luminescent organic and/or inorganic and/or organometallic dye, a pigment and/or a complex compound.

In a further embodiment variant, a plurality of spectra are predetermined, which are associated with different predetermined materials, each with at least one nanoparticle marker for (e.g. uniquely) identifying the respective predetermined material (e.g. plastic material, preferably PA CF, PA, TPU, PLA or Tough PLA), and a match with one of the plurality of predetermined spectra is evaluated. Advantageously, the method/terminal can thus be applied to different components made of different materials in order to ascertain in each case whether the respective component is made of the material desired for the intended use.

Preferably, the plurality of predetermined spectra can be stored on a data store (e.g. the evaluation device, the mobile terminal and/or a server device) and/or received via a (e.g. wireless) communication interface (e.g. radio, WLAN, Bluetooth, NFC and/or infrared communication interface) (e.g. of the mobile terminal).

In one exemplary embodiment, the different predetermined materials, for (e.g. uniquely) identifying the respective predetermined material, differ by at least one of:
different weight and/or volume proportions of the same nanoparticle marker;
different nanoparticle markers;
different nanoparticle marker mixtures, in each case of a plurality of different nanoparticle markers; and
different weight and/or volume proportions, in each case of a plurality of different nanoparticle markers.

Advantageously, a unique code can be provided by the respective at least one nanoparticle marker of the respective predetermined material for the unique identification of this predetermined material.

A further aspect of the present disclosure relates to a method for producing a component for a container treatment plant. The method comprises mixing a base material granulate, preferably plastic granulate (e.g. PA CF, PA, TPU, PLA or Tough PLA granulate), with one nanoparticle marker (marker made of nanoparticles) or a plurality of different nanoparticle markers (markers made of nanoparticles) to form a mixture. The method further comprises extruding the mixture to form a filament. The method further comprises producing the (e.g. entire) component from the filament via an additive manufacturing device. Advantageously, the method enables the same advantages to be achieved as have already been described herein with reference to the method for identifying a material.

In an exemplary embodiment, the component is formed entirely from a plurality of adjacent additively manufactured (e.g., plastic) material layers (e.g., PA CF, PA, TPU, PLA, or Tough PLA material layers), and all material layers comprise one or more different nanoparticle markers.

In a further exemplary embodiment, the component is a wearing part, a spare part, a chain, a sprocket or a gear. Alternatively or additionally, the at least one nanoparticle marker has a total volume and/or weight proportion in the component of ≥0.5% and/or ≤3% (e.g. ≥0.6% and/or ≤1%). Alternatively or additionally, the at least one nanoparticle marker is a luminescent organic and/or inorganic and/or organometallic dye, a pigment and/or a complex compound.

A further aspect of the present disclosure relates to a container treatment plant having the component and/or the mobile terminal.

Preferably, the container treatment plant can be designed for controlling the temperature of, producing, cleaning, coating, testing, filling, closing, pasteurizing, labeling, printing, marking, laser marking, and/or packaging containers for liquid or pasty media, preferably beverages, liquid foodstuffs, or products from the pharmaceutical or healthcare industry.

For example, the containers can be realized as bottles, cans, canisters, cartons, vials, tubes, etc.

Preferably, the term “evaluation device” can refer to an electronic system (e.g. designed as a driver circuit or with microprocessor(s) and data memory) which, depending on the design, can perform control tasks and/or regulation tasks and/or processing tasks. Although the term “control” is used herein, this can also comprise or be understood as “regulate” or “feedback-control” and/or “process.”

The preferred embodiments and features of the invention described above can be combined with one another as desired.

### BRIEF DESCRIPTION OF THE FIGURE

Further details and advantages of the invention are described below with reference to the accompanying drawing. In the drawing:

FIG. 1 shows a schematic illustration of a method for testing a component in accordance with an exemplary embodiment of the present disclosure.

### DETAILED DESCRIPTION OF EMBODIMENTS

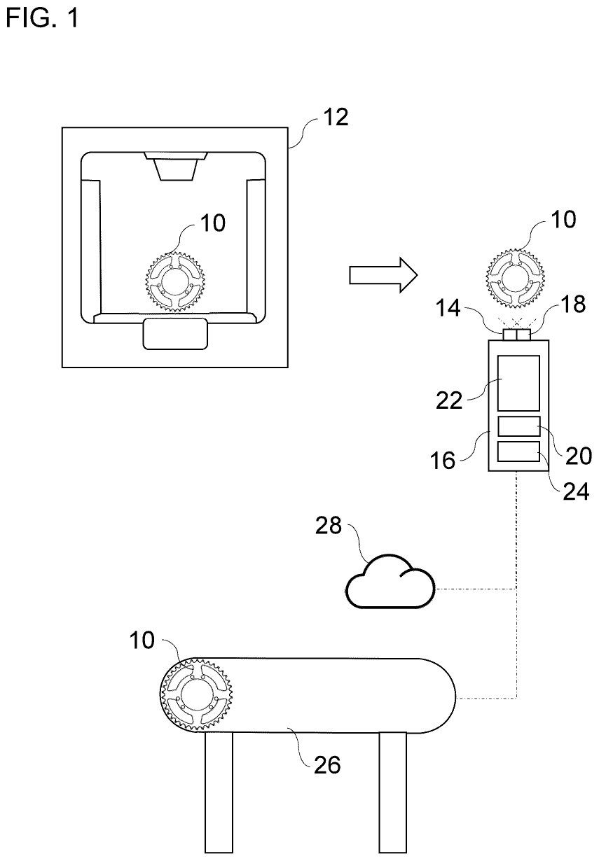

FIG. 1 shows purely schematically a method for testing a component 10. The method is preferably used in a container treatment plant.

Preferably, component 10 is a wearing part or a spare part. Particularly preferably, the component 10 is a sprocket, as shown in FIG. 1, or a gear or a chain (e.g. drive chain or conveyor chain). Preferably, the component 10 can/is to be used in a container treatment plant, e.g. in a machine 26 of the container treatment plant.

The component 10 is produced via an additive manufacturing device 12, e.g. a 3D printer.

The component 10 is irradiated with electromagnetic radiation via a radiation source 14. The radiation source 14 can, for example, be integrated into a mobile terminal 16.

A spectrum of the irradiated component 10 is recorded via a recording device 18. The spectrum can, for example, be an emission and/or absorption spectrum of the irradiated component 10. The recording device 18 can preferably also be integrated in the mobile terminal 16.

The recorded spectrum is evaluated via an evaluation device 20. The evaluation device 20 can preferably also be integrated in the mobile terminal 16. However, it is also possible for the recorded spectrum to be transmitted via a communication interface 24 of the mobile terminal 16 to a server device 28 with its own evaluation device for evaluation (e.g. via a local or global network, e.g. the Internet).

During the evaluation, the recorded spectrum is checked for a match with a predetermined spectrum. The predetermined spectrum is associated with or identifies a predetermined material having at least one nanoparticle marker. The predetermined spectrum can thus clearly identify the predetermined material. The predetermined spectrum can, for example, be stored on a data store of the evaluation device 20 or can be received via the communication interface 24 of the mobile terminal 16, e.g. from the server device 28. The predetermined spectrum or its characteristic properties can, for example, be determined beforehand in tests on the predetermined material with the at least one nanoparticle marker.

Preferably, the communication interface 24 can be a wireless communication interface. For example, the communication interface 24 can be a radio, WLAN, Bluetooth, NFC and/or infrared communication interface 24.

The evaluation can be used to check whether or not the component 10 was actually produced from the desired (correct), predetermined material using the additive manufacturing device 12. The component 10 could, for example, be produced as desired as described below.

First, a base material granulate can be mixed with one or more nanoparticle markers to form a mixture.

The base material granulate is preferably a plastic granulate, e.g. a PA CF granulate (carbon fiber-reinforced polyamide granulate), a PA granulate (polyamide granulate), a TPU granulate (thermoplastic polyurethane granulate) or PLA granulate (polylactide granulate), e.g. Tough PLA granulate.

The at least one nanoparticle marker can preferably be a luminescent organic and/or inorganic and/or organometallic dye, a pigment and/or a complex compound.

The mixture with the base material granulate and the at least one nanoparticle marker can then be extruded by an extruder to form a (3D printer) filament. At a predetermined pressure and temperature, the filament can be pressed out of a nozzle of the extruder.

The filament can, for example, be wound onto a spool for the additive manufacturing device 12.

The component 10 can then be additively manufactured from the filament using the additive manufacturing device 12. Preferably, the component 10 can be made entirely from the filament. For example, the component 10 may be formed entirely from a plurality of adjacent additively manufactured material layers, and all material layers may comprise at least one nanoparticle marker.

Preferably, the at least one nanoparticle marker has a total volume and/or weight proportion in the component 10 or the filament of ≥0.5% and/or ≤3%.

In the following, reference is again made to the evaluation for a match between the recorded spectrum and the predetermined spectrum. Depending on the evaluation, a result of the evaluation can be output via an output device 22 after the evaluation. The output device 22 preferably has a visual display and/or a loudspeaker. The output device 22 can preferably also be integrated in the mobile terminal 16.

Depending on the result of the evaluation, different information can be output via the output device 22.

For example, information about a lack of match, preferably visual and/or acoustic information, can be output if no match is found during the evaluation. The visual information can be output, for example, with a colored, preferably red, symbol, e.g. in the shape of a cross. Alternatively or additionally, an acoustic warning tone can be output.

The user then knows, for example, that the component 10 was made from the wrong material and is therefore not suitable or only insufficiently suitable for the intended use.

Alternatively, for example, information, preferably visual and/or acoustic information, about an existing match can be output if a match is found during the evaluation. The visual information can be output, for example, with a colored, preferably green, symbol, e.g. in the form of a check mark. Alternatively or additionally, an acoustic confirmation tone can be output, for example. The user then knows, for example, that the component 10 was made from the correct/desired material and is therefore suitable for the intended use.

It is also possible, for example, for information about the predetermined material to be output if, during the evaluation, a match with the predetermined spectrum associated with this predetermined material is found.

It is also possible, for example, for additional information associated with the predetermined material to be retrieved from a data store if, during the evaluation, a match with the predetermined spectrum associated with this predetermined material is found.

Preferably, this additional information may comprise at least one of a material number, a material designation, a batch number, a material production time, a digital reference (link) to an electronic file (e.g. document), a data sheet, an instruction manual and a material composition. The additional information can, for example, be stored in a database. Finally, the retrieved additional information can be output, preferably visually and/or acoustically, via the output device 22.

It is also possible that operation of a machine 26 in which the component 10 is installed or is to be installed is only enabled if, during the evaluation, a match is found with a predetermined spectrum associated with a predetermined material that is desired for this machine 26 and that has at least one nanoparticle marker. For example, the evaluation device 20 can communicate with a machine controller of the machine 26 in order to enable the machine 26.

It is also possible to adapt an operation of the machine 26 depending on the result of the evaluation. For example, the machine 26 can only be operated at its full power or speed if, during the evaluation, a match is found with a predetermined spectrum associated with a predetermined material that is desired for this machine 26 and that has at least one nanoparticle marker.

The machine 26 is particularly preferably a container transport machine or container treatment machine, e.g. for tempering, producing, cleaning, coating, testing, filling, sealing, pasteurizing, labeling, printing on, marking, laser marking and/or packaging containers.

It is also possible that the result of the evaluation is send to a server device 28, preferably a cloud server device. The server device 28 can, for example, be a server device of a manufacturer of the machine 26.

An example is explained above in which the recorded spectrum is checked for a match with only one predetermined spectrum during the evaluation. However, it is also possible that a plurality of spectra are predetermined. The plurality of spectra are associated with different predetermined materials, each with at least one nanoparticle marker. In this way, a match with one of the plurality of predetermined spectra can be evaluated. In other words, it is possible to evaluate whether there is a match at all with one of the predetermined spectra and, if so, with which of the predetermined spectra there is a match.

The different predetermined materials can be clearly identifiable or distinguishable from one another by, for example, different weight and/or volume proportions of the same nanoparticle marker, different nanoparticle markers, different nanoparticle marker mixtures, in each case of a plurality of different nanoparticle markers and/or different weight and/or volume proportions, in each case of a plurality of different nanoparticle markers.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 Component
12 Additive manufacturing device
14 Radiation source
16 Mobile terminal
18 Recording device
20 Evaluation device
22 Output device
24 Communication interface
26 Machine
28 Server device

What is claimed is:

1. A method for identifying a material of a component, wherein the method comprises:
providing the component, which is manufactured via an additive manufacturing device;
irradiating the component with electromagnetic radiation via a radiation source;
recording a spectrum of the irradiated component via a recording device;
evaluating the recorded spectrum for a match with at least one predetermined spectrum which is associated with a predetermined material having at least one nanoparticle marker for identifying the predetermined material via an evaluation device; and
outputting a result of the evaluation via an output device.

2. The method according to claim 1, wherein:
the radiation source, the recording device and the output device are integrated in a mobile terminal.

3. The method according to claim 1, wherein at least one of:
the component is of a container treatment plant;
the spectrum is one of an emission and an absorption spectrum;
the radiation source, the recording device and the output device are integrated in a handheld mobile terminal;
the radiation source, the recording device, the output device, and the evaluation device, are integrated in a mobile terminal; and
the radiation source, the recording device, the output device, and the evaluation device, are integrated in a handheld mobile terminal.

4. The method according to claim 1, further comprising:
retrieving, when a match with the predetermined spectrum associated with the predetermined material is found during the evaluation, additional information associated with this predetermined material from a data store; and
outputting the retrieved additional information via the output device.

5. The method according to claim 4, wherein the additional information comprises at least one of a material number, a material designation, a batch number, a material production time, a digital reference to an electronic file, a data sheet, an instruction manual and a material composition.

6. The method according to claim 1, further comprising at least one of the following:
enabling operation of a machine if, during evaluation, a match is found with a predetermined spectrum which is associated with a predetermined material that is desired for this machine and that has at least one nanoparticle marker,
sending the result of the evaluation to a server device; and
adapting an operation of a machine depending on the result of the evaluation.

7. The method according to claim 6, wherein the server device is a cloud server device.

8. The method according to claim 1, wherein at least one of:
the component is formed entirely from a plurality of adjacent additively manufactured material layers and all material layers have one or more different nanoparticle markers; and
providing the component comprises:
mixing a base material granulate with one nanoparticle marker or a plurality of different nanoparticle markers to form a mixture;
extruding the mixture to form a filament; and
producing the component from the filament via the additive manufacturing device.

9. The method according to claim 8, wherein the base material granulate is plastic granulate.

10. The method according to claim 1, wherein at least one of the following is fulfilled:
when the result is output, information about a lack of match is output if no match is found during the evaluation;
when the result is output, information about an existing match is output if a match is found during the evaluation; and
when the result is output, information about the predetermined material is output if, during the evaluation, a match with the predetermined spectrum associated with this predetermined material is found.

11. The method according to claim 1, wherein:
predetermining a plurality of spectra, which are associated with different predetermined materials, each with at least one nanoparticle marker for identifying the respective predetermined material; and
evaluating the recorded spectrum for a match with one of the plurality of predetermined spectra.

12. The method according to claim 11, wherein the different predetermined materials, for identifying the respective predetermined material, differ by at least one of:
at least one of different weight and volume proportions of the same nanoparticle marker;
different nanoparticle markers;
different nanoparticle marker mixtures, in each case of a plurality of different nanoparticle markers; and
at least one of different weight and volume proportions, in each case of a plurality of different nanoparticle markers.

13. A mobile terminal for identifying a material of an additively manufactured component, comprising:
a radiation source for irradiating a component with electromagnetic radiation;
a recording device for recording a spectrum of the irradiated component;
an output device for outputting information to a user; and
an evaluation device that is configured to at least one of:
to evaluate a spectrum, recorded via the recording device, of the component irradiated via the radiation source for a match with at least one predetermined spectrum associated with a predetermined material having at least one nanoparticle marker for identifying the predetermined material, and
to send a spectrum, recorded via the recording device, of the component irradiated via the radiation source for the purpose of evaluation for a match with at least one predetermined spectrum associated with a predetermined material having at least one nanoparticle marker for identifying the predetermined material, to a server device via a communication interface and to receive a result of the evaluation from the server device via the communication interface; and
the evaluation device is further configured to operate the output device to output a/the result of the evaluation.

14. The mobile terminal according to claim 13, wherein the evaluation device is further configured:
to operate a communication interface of the evaluation device in order to send the result of the evaluation to at least one of a machine and a server device;
to operate the output device in order to output additional information associated with the predetermined material if, during the evaluation, a match with the predetermined spectrum associated with this predetermined material is found.

15. The mobile terminal according to claim 13, wherein at least one of:
the mobile terminal is a handheld mobile terminal;
the spectrum is one of an emission and an absorption spectrum; and
the evaluation device is further configured to operate the output device in order to output additional information associated with the predetermined material if, during the evaluation, a match with the predetermined spectrum associated with this predetermined material is found, wherein the additional information includes at least one of a material number, a material designation, a batch number, a material production time, a digital reference to an electronic file, a data sheet, operating instructions and a material composition.

16. The mobile terminal according to claim 13, wherein:
the at least one nanoparticle marker has at least one of a total volume and weight proportion in the predetermined material of at least one of ≥0.5% and ≤3%.

17. The mobile terminal according to claim 13, wherein:
the at least one nanoparticle marker is at least one of a luminescent organic, inorganic, and organometallic dye, ant at least one of a pigment and a complex compound.

18. A method for producing a component for a container treatment plant, wherein the method comprises:
mixing a base material granulate with one nanoparticle marker or a plurality of different nanoparticle markers to form a mixture;
extruding the mixture to form a filament; and
producing the component from the filament via an additive manufacturing device.

19. A component for a container treatment plant, comprising:
the component being formed entirely from a plurality of adjacent material layers and all material layers include one or more different nanoparticle markers.

20. The component according to claim 19, wherein at least one of the following is fulfilled:
the component is a wearing part, a spare part, a chain, a sprocket or a gear;
the at least one nanoparticle marker has at least one of a total volume and weight proportion in the component of at least one of ≥0.5% and ≤3%; and
the at least one nanoparticle marker is at least one of a luminescent organic, inorganic, and organometallic dye, and at least one of a pigment and a complex compound.
